(19) United States
(12) Patent Application Publication
(10) Pub. No.: US 2016/0307120 A1
(43) Pub. Date: Oct. 20, 2016

(54) SYSTEM AND DISPLAY SCREEN OR PORTION THEREOF WITH GRAPHICAL USER INTERFACE FOR MANAGING SERVICE OPERATIONS

(71) Applicant: HONEYWELL INTERNATIONAL INC., Morristown, NJ (US)

(72) Inventors: Christopher M. Ortega, Louisville, KY (US); Joseph M. Michels, Simpsonville, KY (US); Robert J. Teta, Louisville, KY (US); Robert H. Brockelsby, La Grange, KY (US); Jeffrey D. Netland, White Plains, NY (US)

(21) Appl. No.: 14/688,726

(22) Filed: Apr. 16, 2015

(51) Int. Cl. G06Q 10/02

(52) U.S. Cl. CPC G06Q 10/02

(57) ABSTRACT

An electronic software application which features a plurality of navigable display screens. The display screens are visually presented on an electronic display of a mobile electronic device and have a graphical user interface for downloading, accessing and inputting information for service appointments. The information is electronically stored on a central computer at a remote location and the mobile electronic device is in wireless communication with the central computer. The display screens visually present selectable computer-generated icons and predetermined designations to select portions of the information to be viewed or input.

### FIELD OF THE INVENTION

Embodiments of the subject invention are directed to a system and display screen or portion thereof with graphical user interface for managing service operations.

### BACKGROUND OF THE INVENTION

The difficulties and complexities of managing a business involving mobile service technicians are generally well known to those of ordinary skill in the art. Common difficulties can include, for example, handling customer calls, scheduling, coordinating and/or dispatching service technicians, handling emergency or high priority matters, modifying and managing service schedules, tracking or monitoring the progress of multiple technicians and maintaining records for billing or invoicing purposes.

In addition, service technicians themselves can additionally face further hassles and frustrations from an organizational, administrative and/or logistical perspective. For example, technicians often have to spend needless time managing their work schedules, communicating with a dispatcher or manager and gathering, completing and transporting excessive amounts of paperwork for various calls. Such issues can result in technicians spending unnecessary time on a service call, not being able to fully complete or properly address a problem at a particular jobsite, unnecessarily traveling to a jobsite where work has already been completed and/or misplacing important paperwork for billing or invoicing their work. Such occurrences ultimately can make a technician less effective and productive.

Thus, in view of such issues, there is a need in the art for a system and method for streamlining the management and operations of a service business so that dispatchers and technicians are able to readily access information regarding a service call or work schedule, communicate availability for a particular job, assign and/or accept service calls, and record and update a service logs and records. It will be recognized that such actions are likely to improve the quality and reliability of the work and the overall productivity of the business.

### BRIEF DESCRIPTION OF THE DRAWINGS

FIG. 1 is a first image of a front view of a display screen or portion thereof with graphical user interface;

FIG. 2 is a second image thereof;

FIG. 3 is a third image thereof;

FIG. 4 is a fourth image thereof;

FIG. 5 is a fifth image thereof;

FIG. 6 is a sixth image thereof;

FIG. 7 is a seventh image thereof;

FIG. 8 is an eighth image thereof;

FIG. 9 is a ninth image thereof;

FIG. 10 is a tenth image thereof;

FIG. 11 is an eleventh image thereof;

FIG. 12 is a twelfth image thereof;

FIG. 13 is a thirteenth image thereof;

FIG. 14 is a fourteenth image thereof;

FIG. 15 is a fifteenth image thereof;

FIG. 16 is a sixteenth image thereof;

FIG. 17 is a seventeenth image thereof;

FIG. 18 is an eighteenth image thereof;

FIG. 19 is a nineteenth image thereof;

FIG. 20 is a twentieth image thereof;

FIG. 21 is a twenty-first image thereof;

FIG. 22 is a twenty-second image thereof;

FIG. 23 is a twenty-third image thereof;

FIG. 24 is a twenty-fourth image thereof;

FIG. 25 is a twenty-fifth image thereof;

FIG. 26 is a twenty-sixth image thereof;

FIG. 27 is a twenty-seventh image thereof;

FIG. 28 is a twenty-eighth image thereof;

FIG. 29 is a twenty-ninth image thereof;

FIG. 30 is a thirtieth image thereof;

FIG. 31 is a thirty-first image thereof;

FIG. 32 is a thirty-second image thereof;

FIG. 33 is a thirty-third image thereof;

FIG. 34 is a thirty-fourth image thereof.

### DETAILED DESCRIPTION

While this invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated or described.

Embodiments of the subject invention are directed to a system for managing service operations which can include a downloadable mobile software application and a display screen or portion thereof with graphical user interface. The system can enable service technicians to view assigned installations, inspections, service calls and jobsite histories directly on a mobile electronic device, such as for example, a smart phone, personal digital assistant or electronic tablet with or without touch screen capabilities. The system can additionally provide an interface between a service technician and dispatcher and can allow technicians to view and update a work schedule in real-time, accept new projects, notify a dispatcher as to the status or completion of a project, obtain information regarding a particular jobsite or equipment being serviced and generate a custom service order or invoice for work performed.

The mobile software application can be installed on a technician's mobile electronic device and can be linked to a web or cloud-based centralized information management program via a public or private data network. The management program can store customer information, details of serviced equipment and systems, event and service history, real-time diagnostic data and technician availability.

In operation, information regarding a service request or system fault can be input into the management program. Such information can be received, for example, by a notification electronically sent from a device or system connected to a web portal or by being manually entered by an operator or dispatcher in response to communication with a customer. Once entered, the system can create a file or record and assign or notify a technician that a request for service has been made.

When the technician is logged into the mobile application, the application can display information regarding the requested service call. Such information can include, for example, the name of the customer and location of where service is to be performed, the equipment or system requiring service, the scheduled or requested date and time for performing the service and whether the service is urgent. Additionally, the application can display information regarding prior work done for the customer or prior work performed on the specific equipment or system that is subject to the present service request.

The application can additionally enable the technician to accept or reject the service request, request additional information regarding the request or propose a modified time for performing the service. Information input into the mobile application by a technician can be communicated to the management program which can update the corresponding file in real-time.

Where a job request is accepted by the technician, the mobile application can schedule the service call and automatically update the technician's calendar or schedule to include the new call. The application can additionally electronically display the technician's service schedule in calendar form for a particular period of time such as for example, service calls scheduled for a given day, week, month, etc. Where desired, the technician can also manually enter a new job into the application or modify a job. Such information can be sent to and shared with the management system.

The application can additionally visually present job site and technician locations on maps in real-time which can enable faster and more efficient response times. The map features can additionally direct or provide navigation instructions for assisting the technician to with locating the jobsite. The system can also identify or alert a technicians when other technicians are in a particular area should the technician need assistance or be unable to reach a jobsite at a scheduled time.

Embodiments further provide functionality to allow the technician to record information regarding a service call. Such information can include the time the technician departed for the jobsite, the time the job was started and the time of completion. The application can further enable the technician to enter information about whether the service was successfully completed or requires further action.

The application can further allow the technician to enter information for generating service orders or invoices for services that were performed. For example, at the completion of a service call, the technician can enter the amount of time billed to the service, the rate level or hourly rate of the technician, the cost of any equipment or materials supplied by the technician and whether a discount is to be applied. The application can process this information into a service order or invoice which can be printed and/or electronically sent to the customer. The service order can separately itemize the costs for labor, materials and other expenses and identify the total amount to be invoiced for a service call.

Embodiments presented herein can further visually present a list of service calls and further present customized lists based on predetermined filters or designations assigned to the individual calls. For example, the system can include one or more status identifiers such as ‘Pending’, ‘Accepted’, ‘Not Accepted’, ‘Rejected’, ‘Scheduled’, ‘Not Scheduled’, ‘Completed’, ‘Billable’, ‘Billed’. Service calls can be assigned one or more identifiers based on information input into the mobile application or the management program. The system can further categorize the calls based on these designations and allow a technician to select one or more designations for display. Thus, where a technician is interested in viewing all ‘Pending’ service calls, the system can display a list of all calls (or all recent calls) designated as ‘Pending’ in the system. The listed service calls can further include other non-selected designations, such as whether a call has been ‘Scheduled’ or ‘Completed.’ Thus, the application provides an organized and efficient system for notifying technicians of the status of service calls.

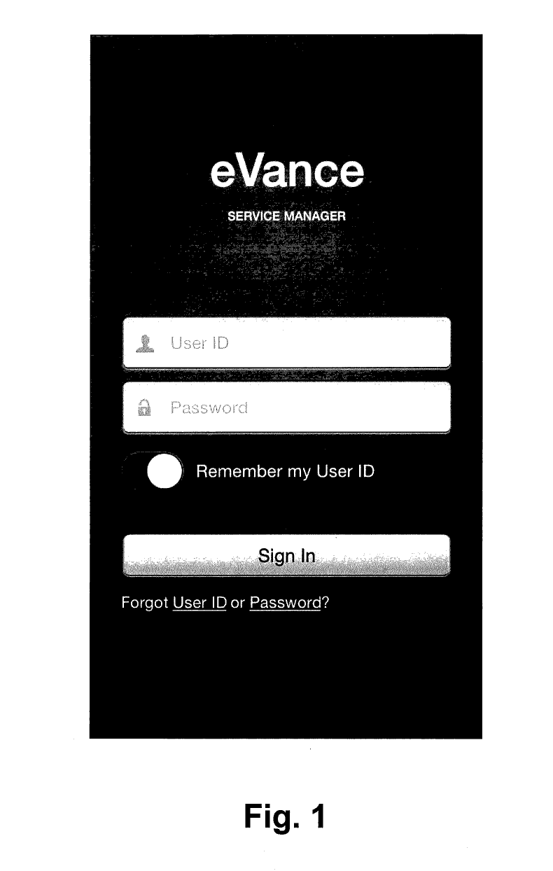

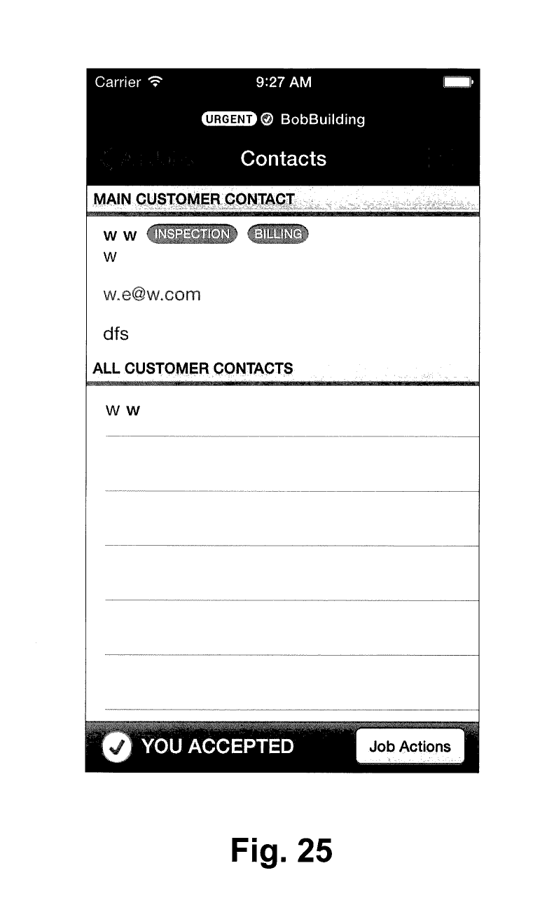

With reference now to the figures, and in particular FIGS. 1-34, there is shown a plurality of images of an electronic display screen or portion thereof with graphical user interface according to embodiments disclosed herein. According to embodiments of the subject invention, the display screen and graphic user interface can be presented by a mobile software application and can be presented on an electronic display of mobile electronic device such as a smartphone, personal digital assistant, notebook computer or electronic tablet.

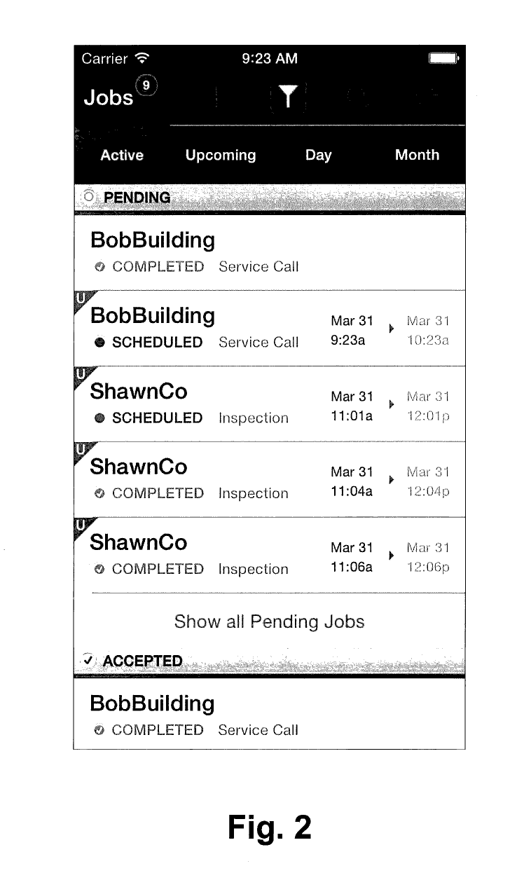

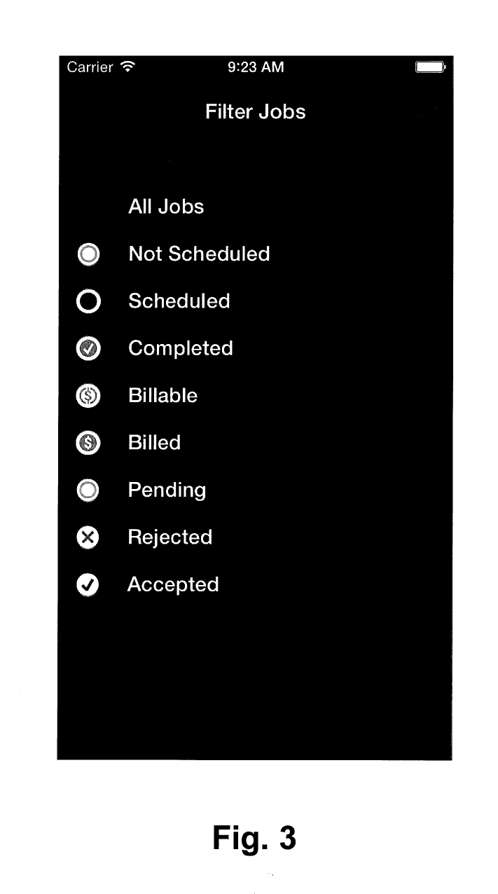

FIGS. 1-34 illustrate pages for accessing and inputting information for accomplishing operations of the type described herein. In particular, FIG. 1 illustrates a Sign In screen which enables a subscriber, technician or user to enter their login credentials to gain access to the system. FIG. 2 illustrates a list of active service jobs in the system, including jobs designated as ‘Pending’, ‘Completed’, ‘Scheduled’ and ‘Accepted.’ The list further includes the date and time for the service call and whether a particular call has been designated as being “Urgent.”. FIG. 3 illustrates a menu or list of predetermined status designations that can be selected for filtering service calls identified on a list of the type illustrated in FIG. 2.

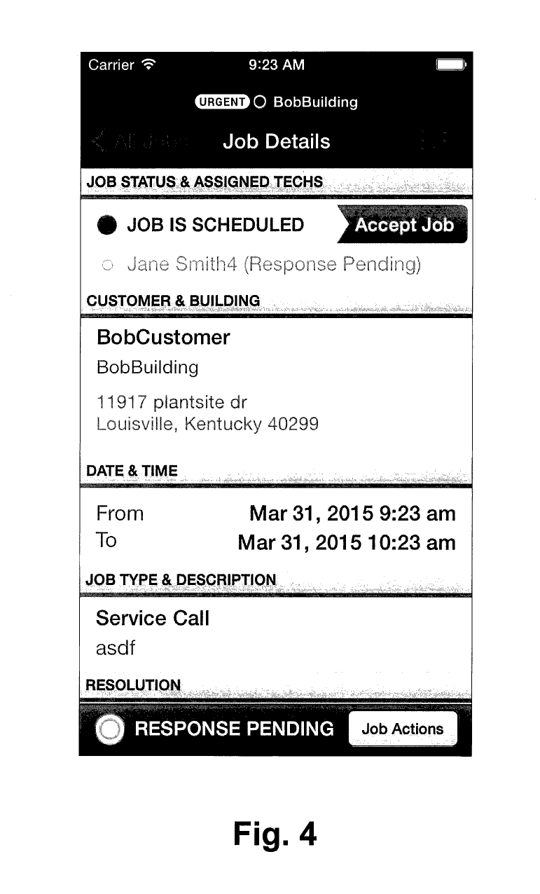

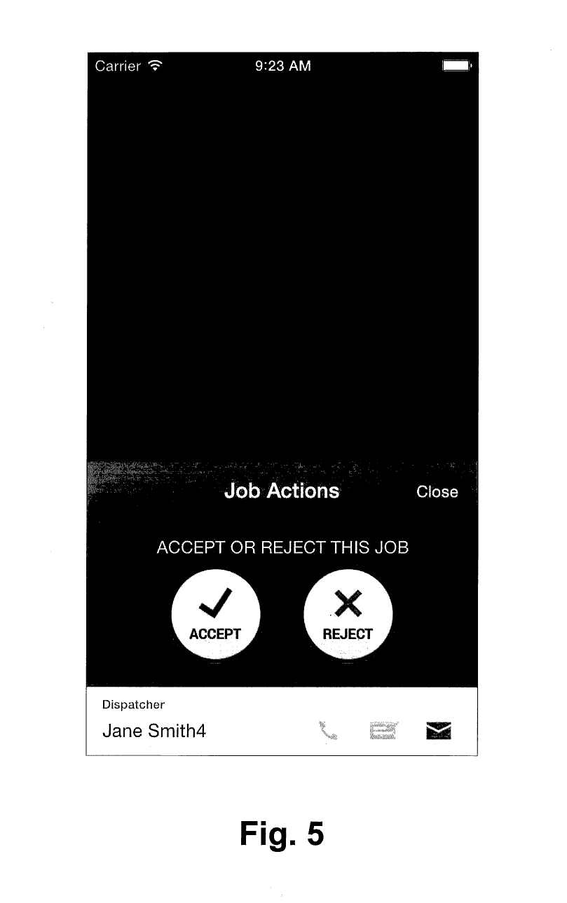

FIG. 4 illustrates a screen showing identifying information for a scheduled service call. Such information can include the name and location of the customer, the date and time of the requested service, a description of the service to be performed and additional information as desired. The display screen enables a technician to accept the job by physically selecting the designated graphic icon displayed on the touch screen of the device. FIG. 5 illustrates an overlay with selectable buttons for accepting or rejecting the service job. The screen of FIG. 5 can additionally display identifying information for the dispatcher and images which can enable the user to contact the dispatcher by initiating a telephone call or sending an email or text message to the dispatcher.

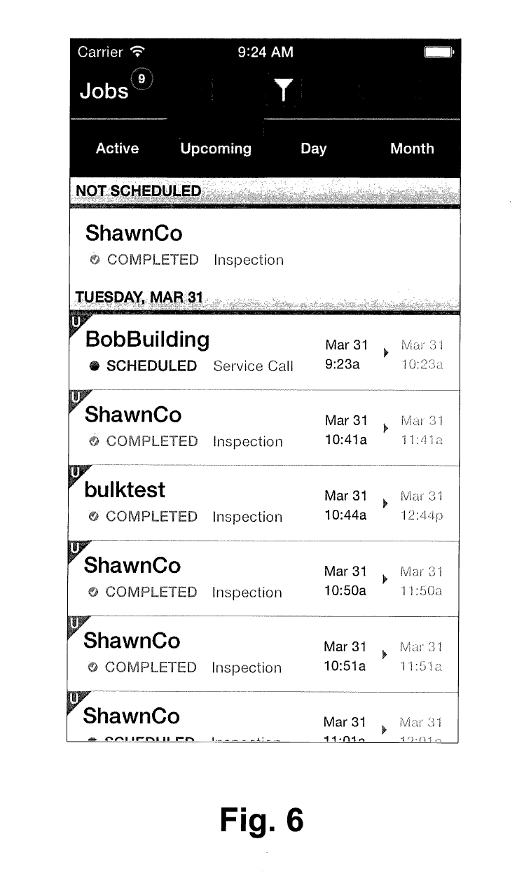

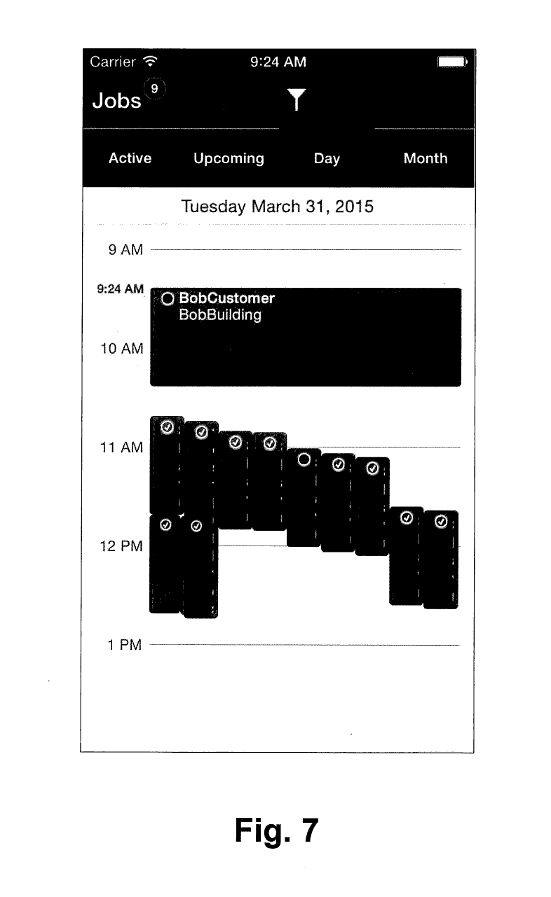

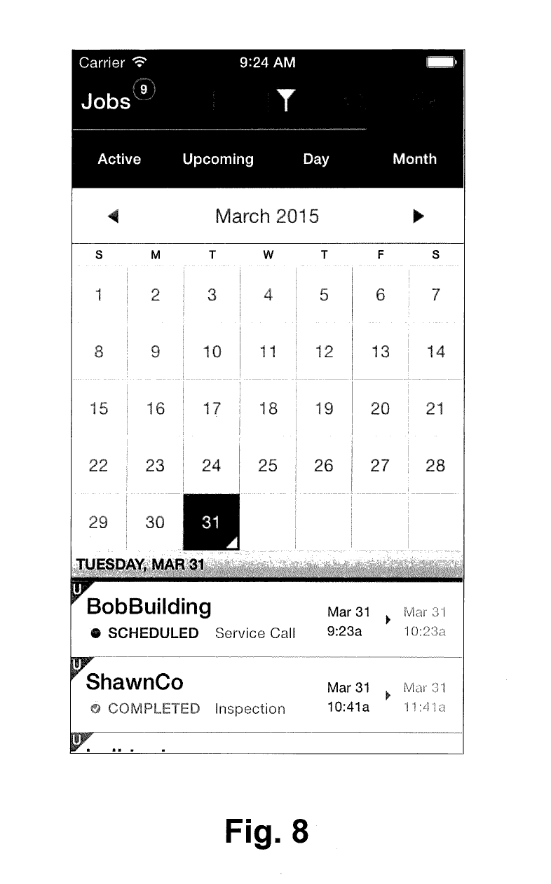

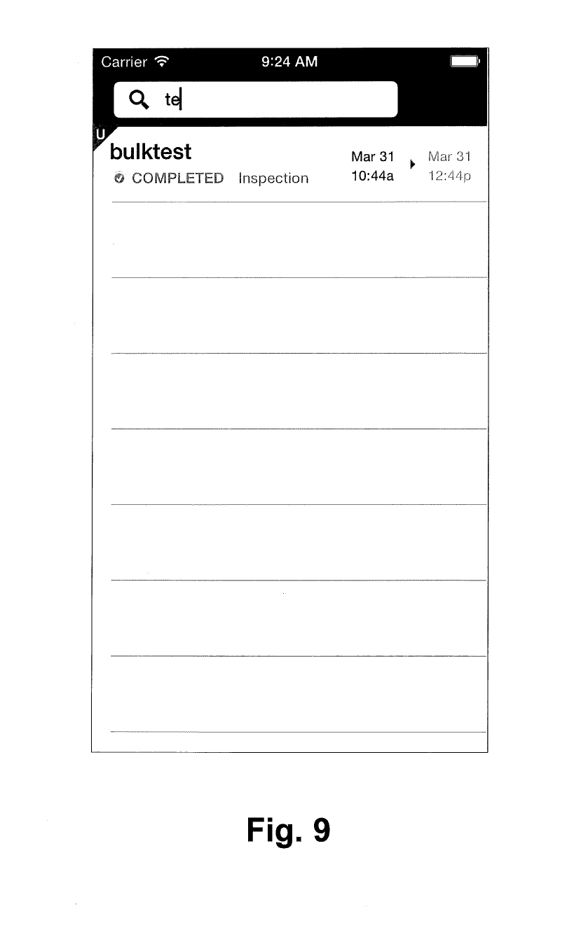

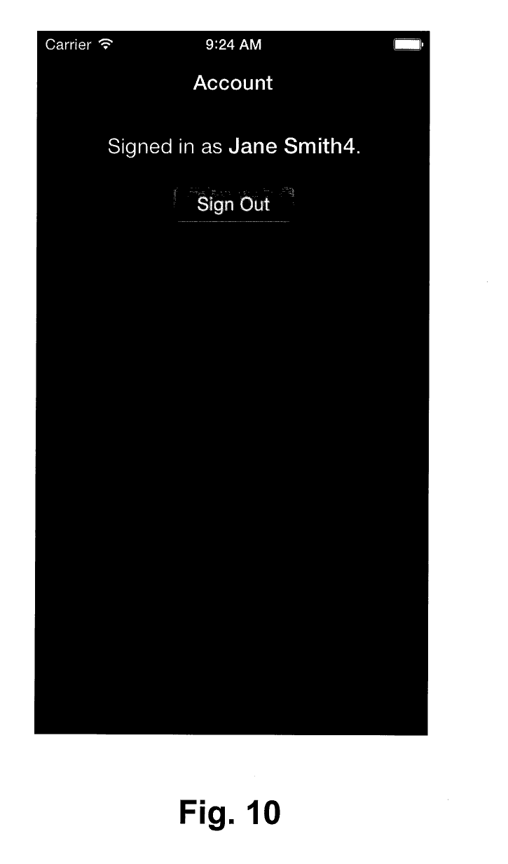

FIG. 6 illustrates a display screen identifying a list of upcoming service jobs. FIG. 7 illustrates a calendar in day-view format with scheduled service jobs visually represented in designated time periods. FIG. 8 illustrates a calendar in month-view format visually presenting service calls for one selected date. FIG. 9 illustrates a search screen that can be accessed for locating service calls or other information stored in the application or system. FIG. 10 illustrates a display identifying the user of the account that is presently active and being used with the mobile application. The display additionally includes a computer generated icon which will logout the user.

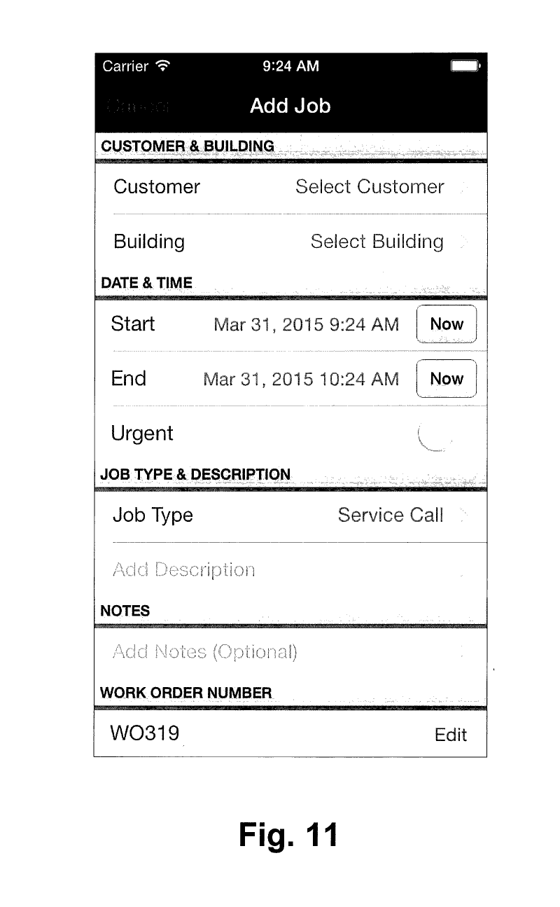

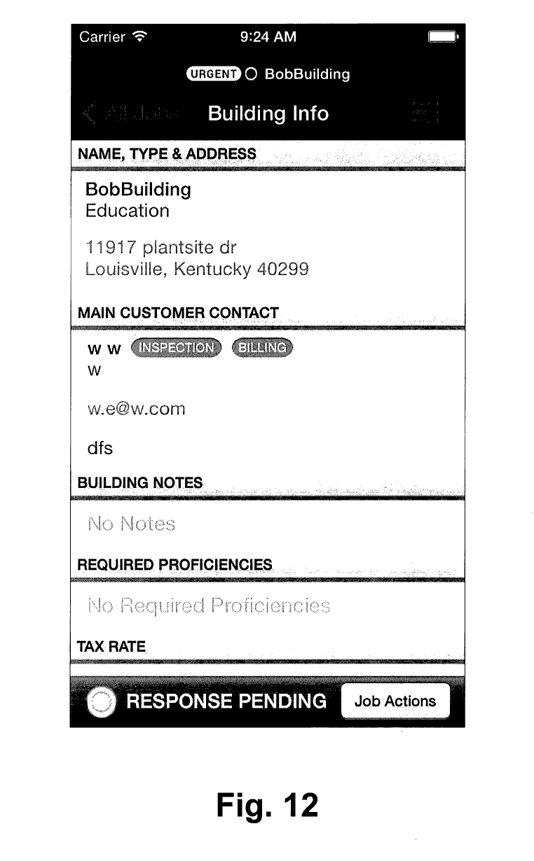

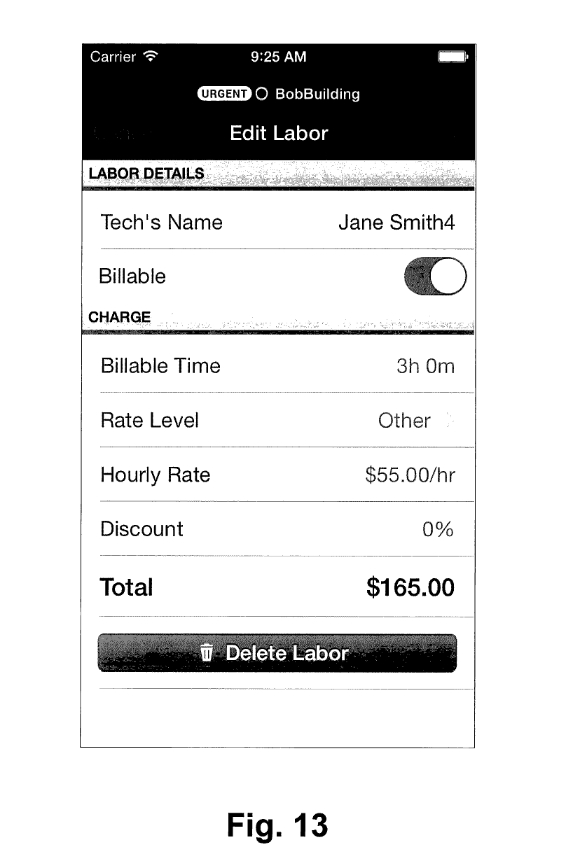

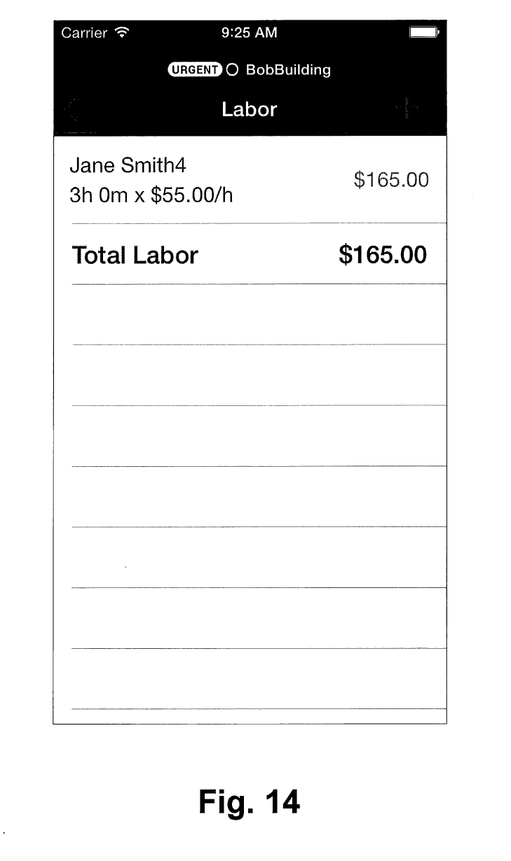

FIG. 11 illustrates a display screen for manually adding a service job. Such display can allow a technician to enter information for scheduling or modifying a service call via the mobile device. FIG. 12 illustrates a display screen identifying information for a selected service call. FIG. 13 illustrates a screen which enables the service technician to set details or information regarding the labor performed in connection with a service call. FIG. 14 illustrates a screen displaying a total amount of labor charges for a particular service call.

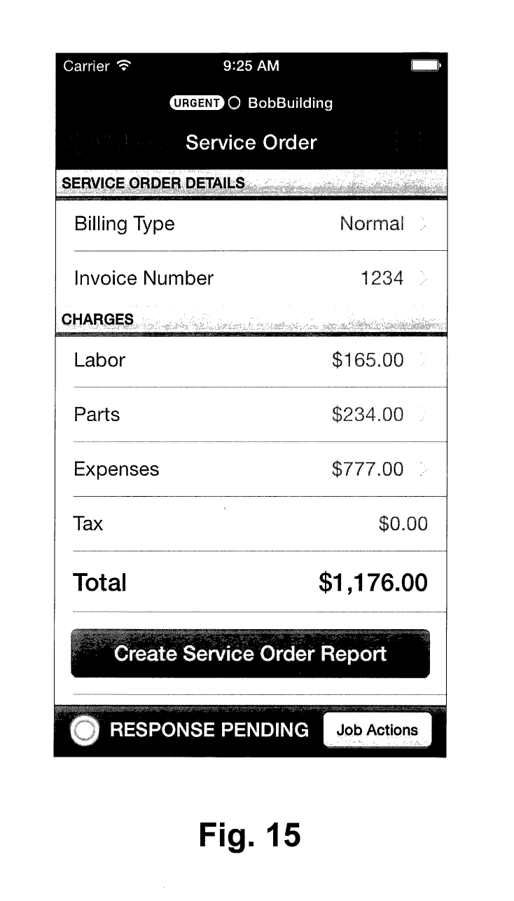

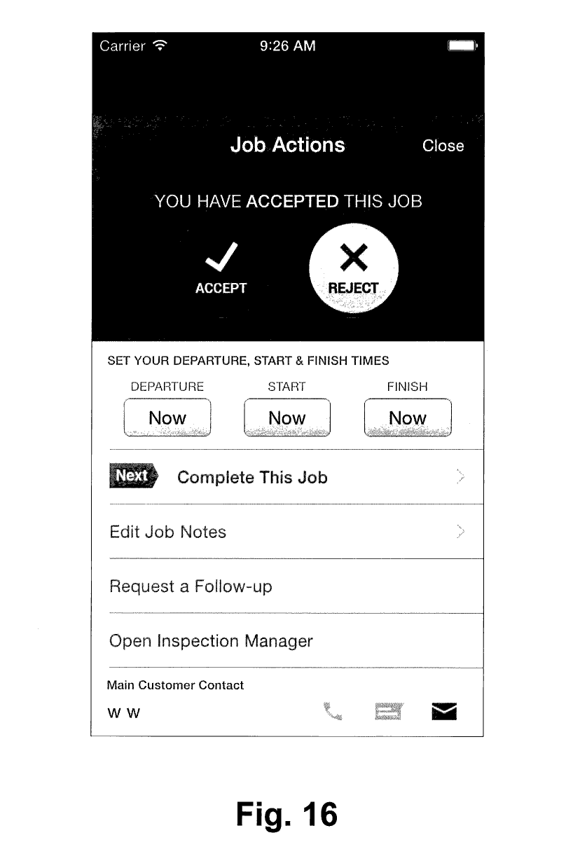

FIG. 15 illustrates a display for generating a service order or invoice for a particular project or service call. The display can allow a user or technician to enter charges or particular materials, labor or expenses and can include a computer generated icon which will generate the service order report. FIG. 16 illustrates a display screen which enables a user or technician to track the length of time for events associated with a service call. For example, the display can include icons which the technician can select upon departure for a service call or at the start or finish of the service call. Thus, in response to the technician's selection(s), the application can track the time interval of a particular event. This information can also be recorded and used in determining charges such as labor or travel costs for the respective service call.

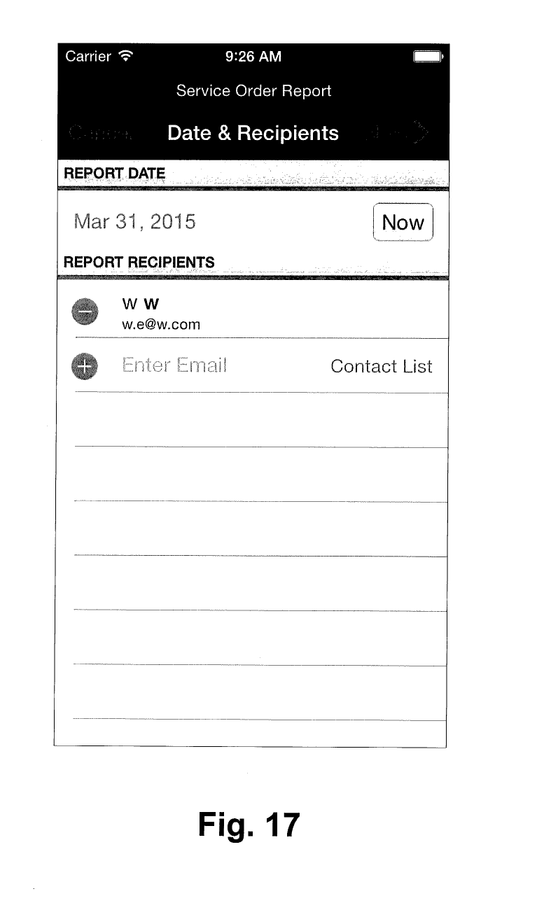

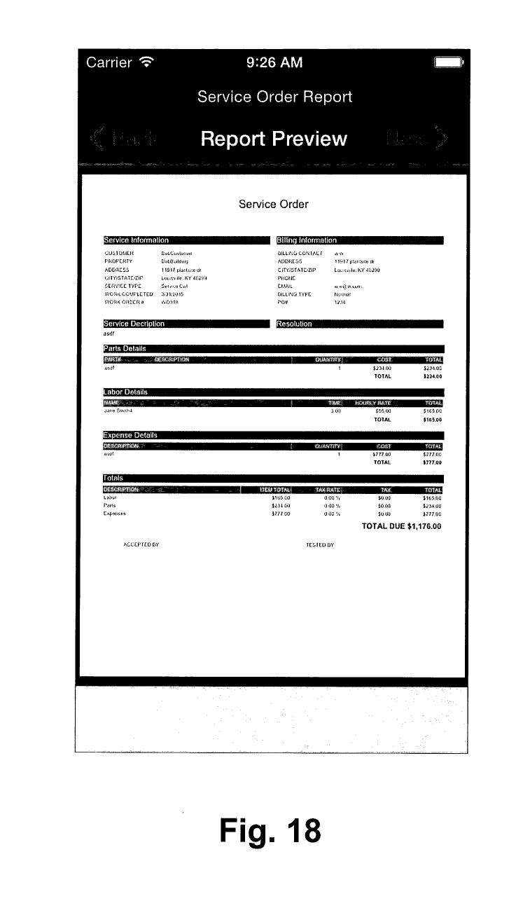

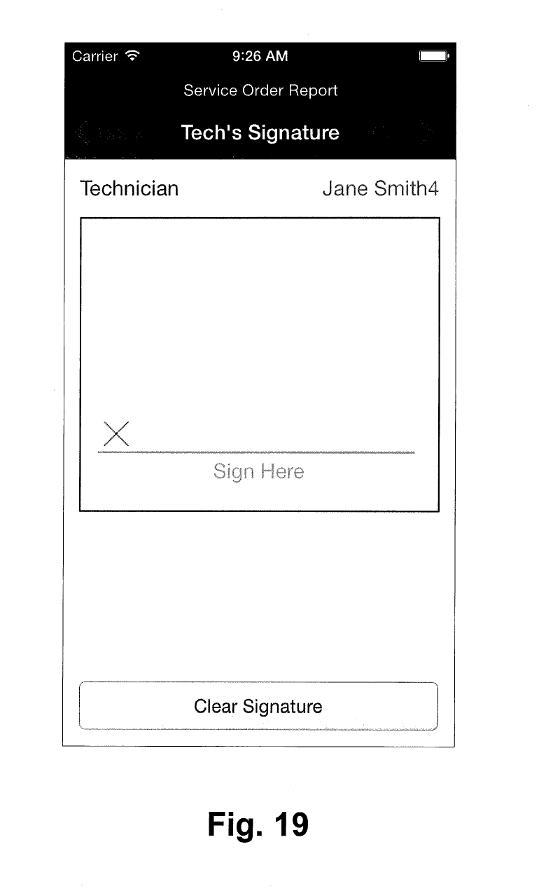

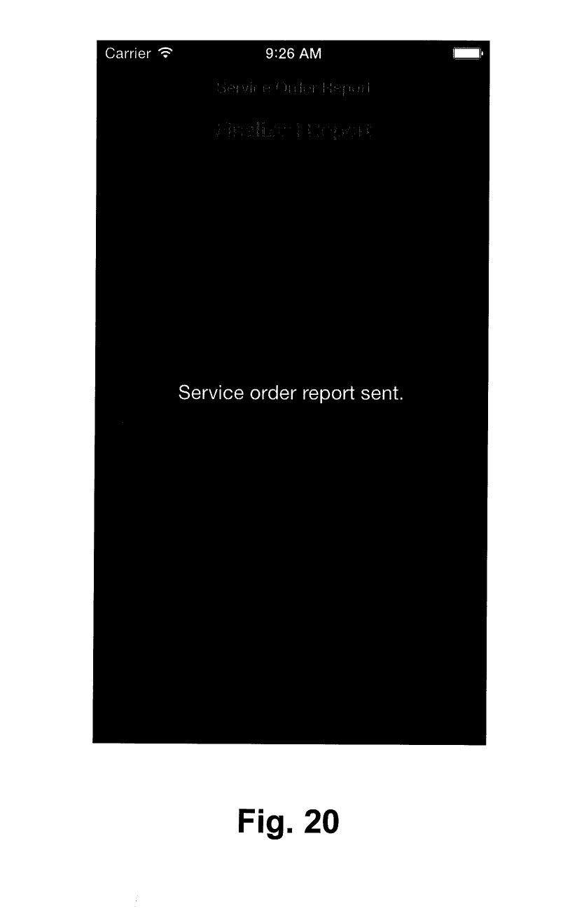

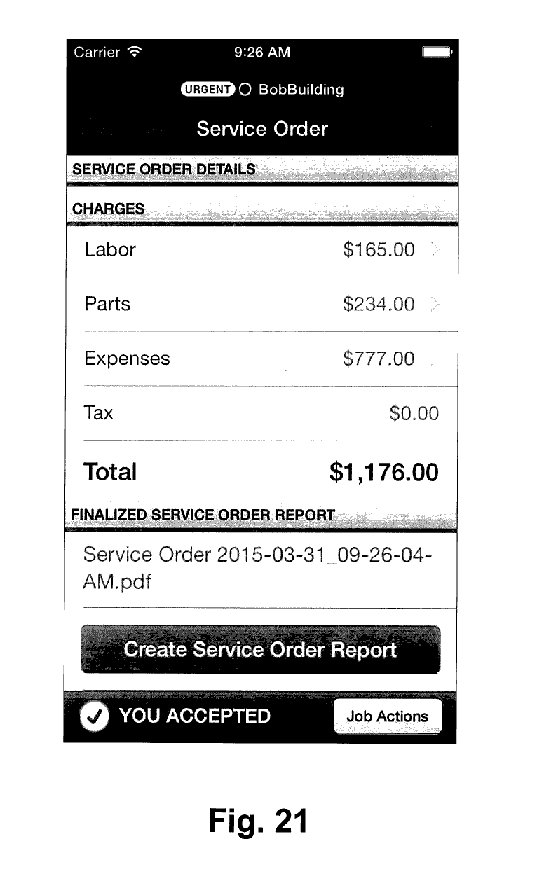

FIG. 17 illustrates a display which can allow a user or technician to enter recipients for distribution of a service order report. FIG. 18 illustrates a display presenting a preview of a service order report for a service call. FIG. 19 illustrates a display screen which can allow a technician or user to electronically sign the service order report by moving an article such as a stylus or finger across the touch screen display. FIG. 20 illustrates a display screen presenting a confirmation notification that a finalized service order report has been sent. FIG. 21 illustrates a display screen presenting information for generating a service order report. The display can allow a user or technician to modify the information presented thereon.

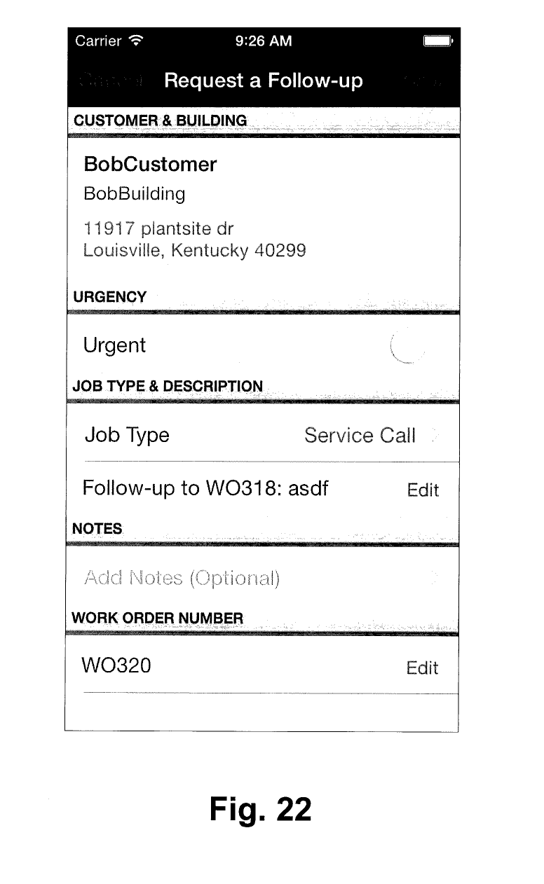

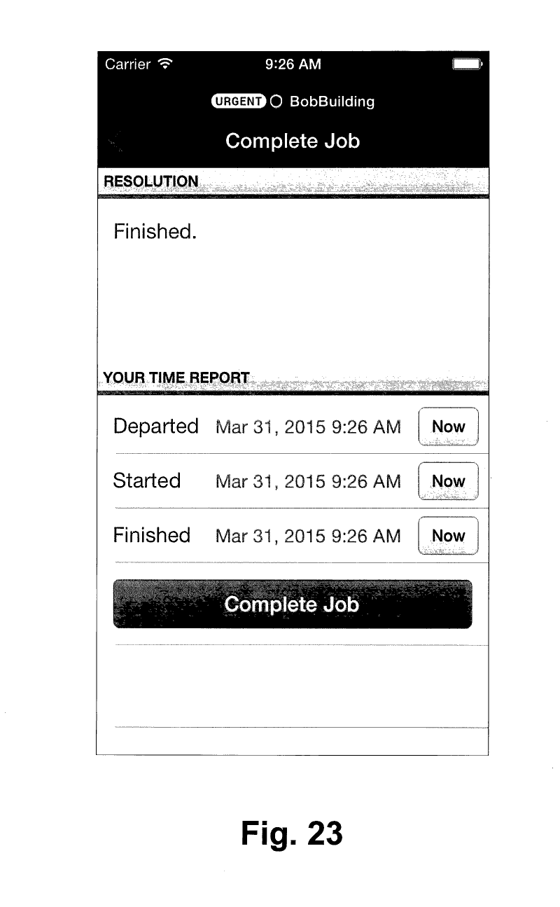

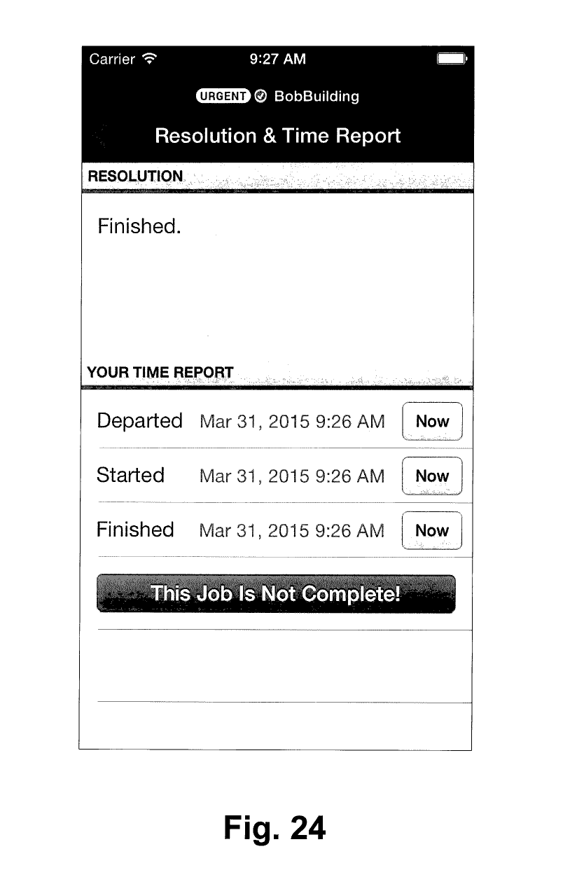

FIG. 22 illustrates a display screen for entering information to schedule or request a follow-up service appointment. The display can enable a user or technician to enter or select information including the name and location of the customer, the type of work to be performed, whether the work is urgent, etc. FIG. 23 illustrates a display screen for a completed service job where the user or technician has used the application to track event times for when he/she departed for the service call, when the work started and when the work was completed. The screen can additionally include selectable computer generated icons which for recording and inputting when a job has been completed. FIG. 24 illustrates a display screen for a service appointment that has not been complete. The display can include an icon or other visual indicia which can visually present a notification to the technician that the job is not yet complete. This display can be presented, for example, where a service order has not yet been issued for a particular service call.

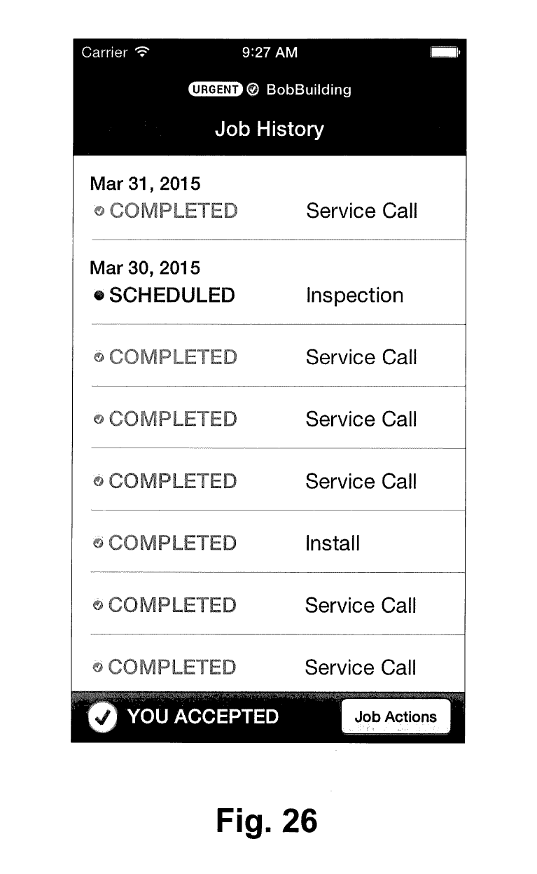

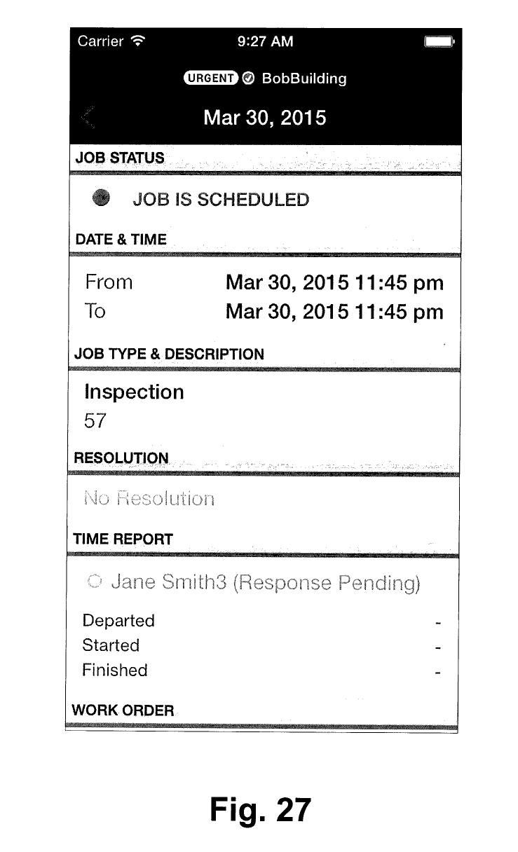

FIG. 24 illustrates a display screen for presenting identifying information for contacts stored in the application or system. The display can include, for example, customer names and addresses, the primary customer contact person, and that person's contact information including email address, phone number or mailing address. The display can additionally include selectable computer generated icons which can enable the user or technician to access inspection or billing information for the client or other job actions. FIG. 26 illustrates a display screen presenting job history information for a contact. Such information can include, for example, a list of all prior, completed or scheduled service appointments, the date and time of such calls, and the type of work that was performed. FIG. 27 illustrates a display screen presenting information regarding a scheduled job. The display can identify the status of the job, date and time of the scheduled service, a brief description as to the nature of the work to be performed, whether the work was successfully resolved or completed and the status of any time report or service order.

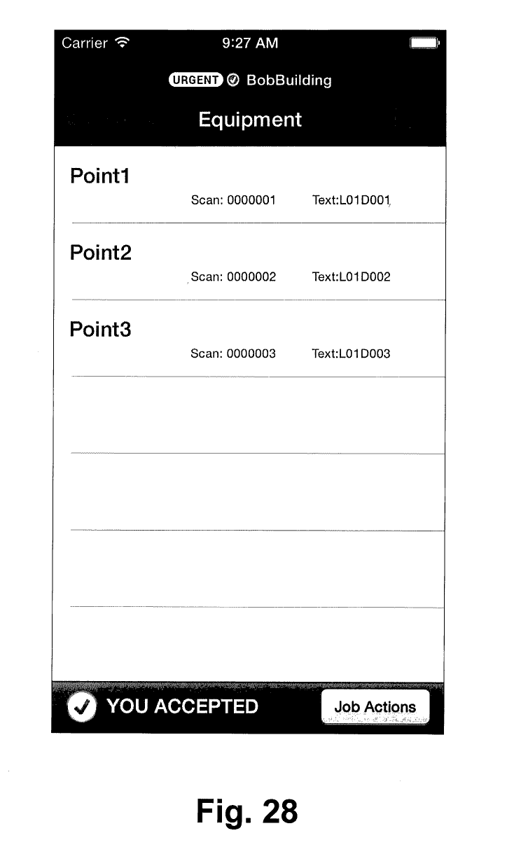

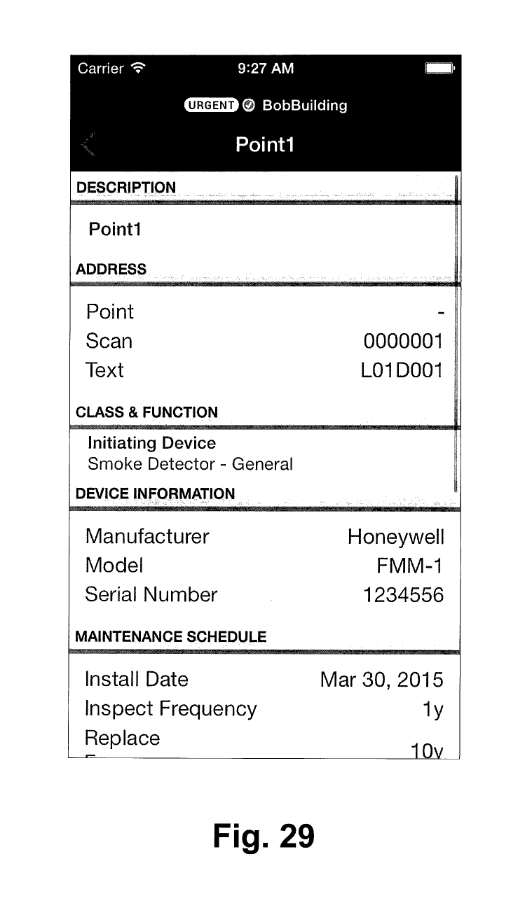

FIG. 28 illustrates a display screen visually presenting information regarding the equipment installed or used at a particular service location as well as equipment used or installed at specific locations at the site. FIG. 29 illustrates a display screen presenting more detailed information regarding the equipment installed or used at a particular service location. As shown, the display can include identifying information such as the specific location of the equipment, the type of equipment, further identifying information such as the manufacturer, model number or serial number prior service record and recommended service events based on recommendations from the manufacturer or industry.

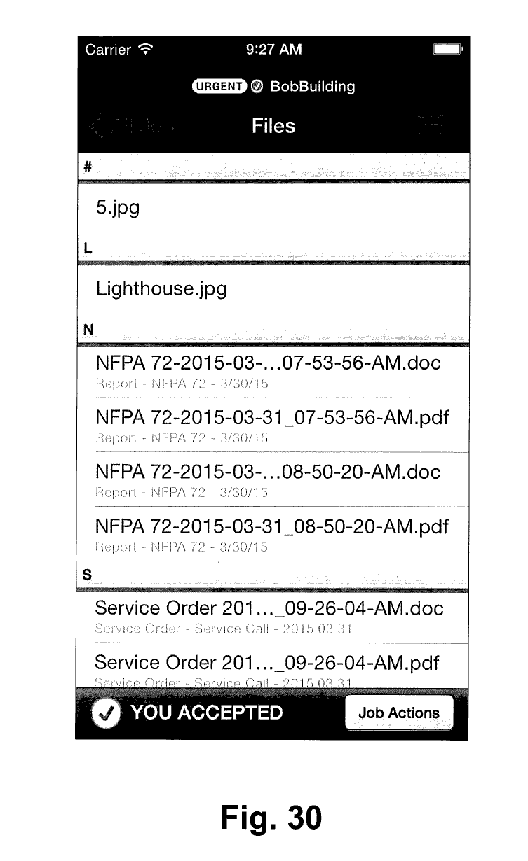

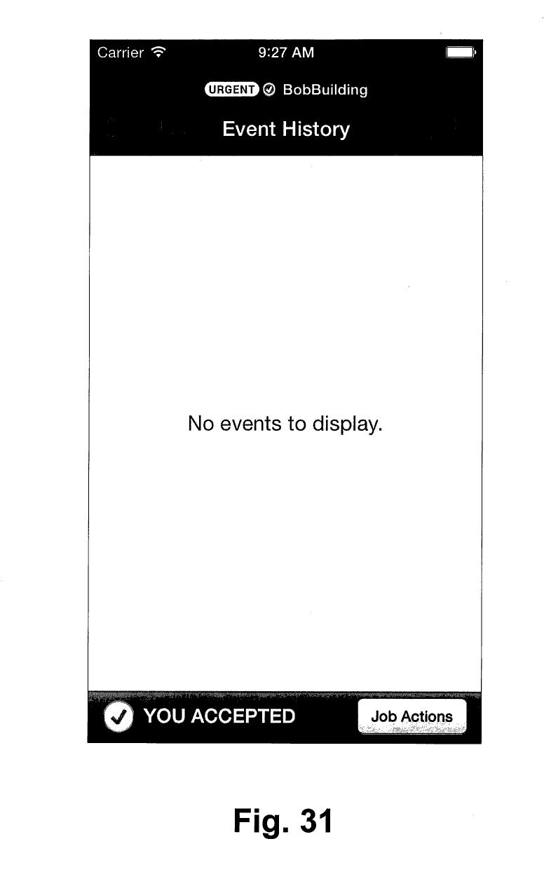

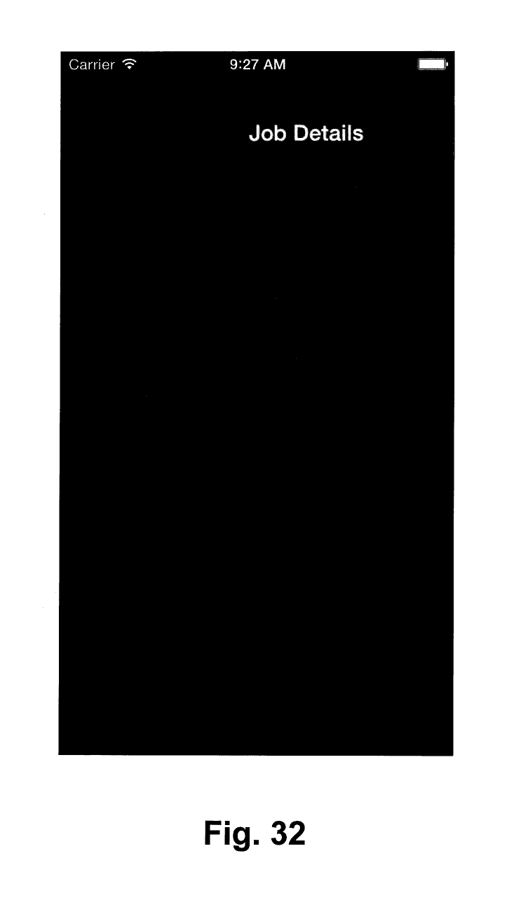

FIG. 30 illustrates a display screen identifying files or documents stored to the device or system. The files can be organized by title, date or customer and can be in selectable form in order for the user or technician to access and view the actual record. FIG. 31 illustrates a display screen that can identify event history for a particular customer or contact. The event history can include, for example, all prior service work performed and be organized chronologically. FIG. 32 illustrates a display screen presenting a menu or list of display screens that can be displayed by the application. The screens can be displayed in selectable form and once selected the application can navigate to the corresponding screen for display.

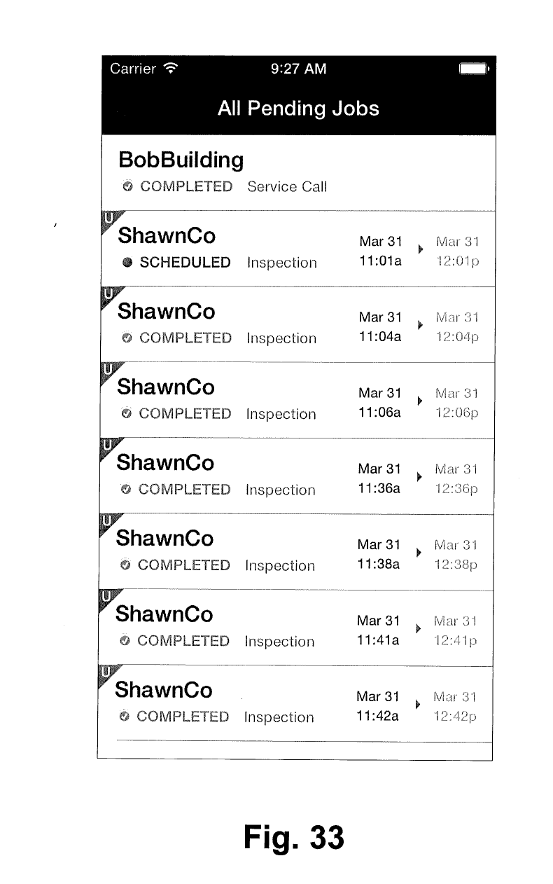

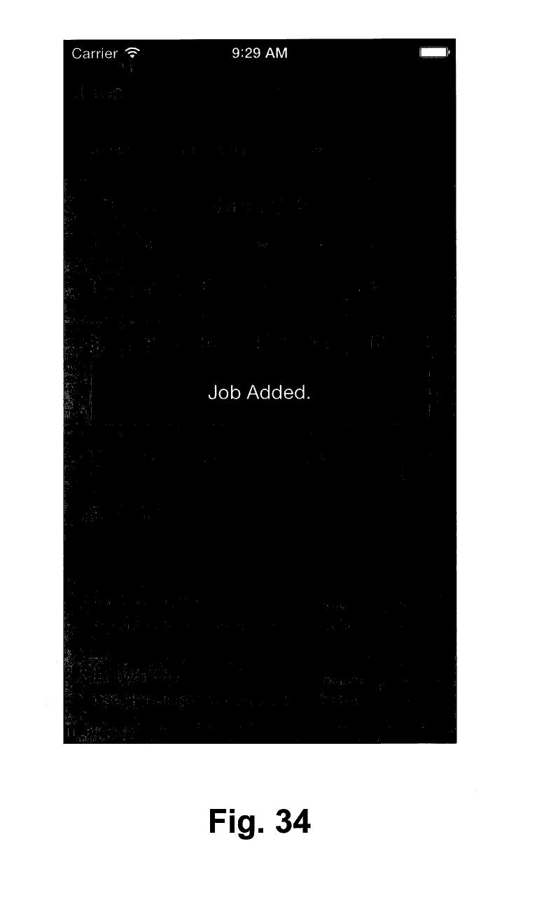

FIG. 33 illustrates a display screen presenting a list of all service appointments designated as “Pending Jobs”. As shown, the display can include the name of the customer or contact, whether the work has been completed or scheduled, whether the work has been designated as being “Urgent”, the type of work to be performed and the date and time of the service appointment. FIG. 34 illustrates a display screen presenting a confirmation notification where a new job has been added to the user's or technician's calendar.

Based on the foregoing, it will be recognized by persons of ordinary skill in the art that embodiments disclosed herein enable technicians to easily view their assigned installations, inspections, service calls and site histories directly from their mobile electronic device. It will be further recognized and understood that embodiments of the subject invention can enhance communication between dispatchers and service technicians for sharing information regarding a customer's equipment, service history and diagnostic information in real time. Persons of ordinary skill will recognize that such possibilities can significantly increase first-time fix rates, eliminating unnecessary service calls by enabling remote problem solving. This can generally lead to improved productivity and profitability.

The present disclosure includes that which is contained in the appended claims as well as that of the forgoing description. Although this invention has been described in its preferred form with a certain degree of particularity, it is understood that the present disclosure has been made only by way of example and that numerous changes to the specific details of the elements, compositions and/or combination of individual features may be resorted to without departing from the novel spirit or scope of the invention. Accordingly, the scope of the invention should be determined not by the specific embodiment(s) illustrated and described, but by the claims below and their equivalents.

From the foregoing, it will be observed that numerous variations and modifications may be effected without departing from the spirit and scope of the invention. It is to be understood that no limitation with respect to the specific invention illustrated or described herein is intended or should be inferred. It is, of course, intended to cover by the appended claims all such modifications as fall within the scope of the claims.

What is claimed is:

1. An electronic software application comprising:
a sequence of navigable display screens visually presented on an electronic display of a mobile electronic device, the display screens having a graphical user interface for downloading, accessing and inputting information for service appointments, the information being electronically stored on a central computer at a remote location, the mobile electronic device in wireless communication with the central computer, the display screens visually presenting selectable computer-generated icons and predetermined designations to select portions of the information for viewing or inputting.
